(19) United States
(12) Patent Application Publication
(10) Pub. No.: US 2026/0112263 A1
(43) Pub. Date: Apr. 23, 2026

(54) ALARM AND GEOLOCATION SYSTEM FOR ANALOGUE WATCHES

(71) Applicant: GT GLOBAL TRACK S.R.L., MONTEROTONDO (RM) (IT)

(72) Inventors: Simone DI DOMENICO, MONTEROTONDO (IT); Antonio CANTAGALLO, ROMA (IT)

(21) Appl. No.: 19/145,757

(22) PCT Filed: Mar. 14, 2024
(86) PCT No.: PCT/IB2024/052496

§ 371 Date: Jul. 3, 2025

(30) Foreign Application Priority Data
Mar. 15, 2023 (IT) 102023000004923

(51) Int. Cl. G08B 25/10; G04G 21/04

(52) U.S. Cl. CPC G08B 25/10; G04G 21/04

(57) ABSTRACT

The present invention concerns an alarm and geolocation system for analogue watches, comprising an alarm device which includes a short range communications module, a processor and an energy storage device, housed in a supporting and containing element which can be fixed permanently to the watch, and a reference device with a short range communications module configured to communicate with the short range communications module of the alarm device, wherein the processor is programmed to calculate, based on at least one parameter of a signal sent by the short range module of the alarm device, the distance (D) between the alarm device and the reference device, and to switch the state of the alarm device as a function of said distance (D).

### BACKGROUND OF THE INVENTION

The present invention concerns an alarm and geolocation system for watches, in particular for analogue watches. More in detail, the invention relates to a system comprising an alarm device produced in such a manner as to be permanently attached to an analogue watch without changing its aesthetics, functionality and authenticity.

The system of the present invention finds particular efficacy of application in the luxury watch sector.

In recent years there has been a constant increase in the use of “luxury” watches, i.e., wristwatches that have an economic value of several tens of thousands of euros, or even hundreds of thousands of euros for the rarest and most precious models.

Although these items are considered “collectors' items”, they are nonetheless worn by the owners not just on special occasions, but sometimes also on a daily basis.

However, in recent times due to the constant increase in cases of loss of possession of these valuable items due to pick-pocketing, snatching or theft, the owners of wristwatches are wearing them less frequently, preferring to store them in a safe place, such as in safes or safety deposit boxes.

The spread of this phenomenon is also confirmed by the conditions that insurance companies apply to the policies to insure this type of item. Generally, these policies only guarantee compensation for the value only when the wristwatch is placed in a safety deposit box, thereby excluding any thefts in circumstances in which it is worn.

In such context, there is consequently the need to provide an apparatus or system which is able to notify, in real time or with a limited delay, one or more interested parties of the potential theft of the wristwatch from the person wearing it, and to monitor the geographical position of the item, in order to make its recovery possible.

In the state of the art there are known anti-theft devices configured to control the distance between an item to be protected and another electronic device, generally carried by the owner of the item (such as a smartphone, a tablet or similar), or the anti-theft device itself. These devices are also configured to generate an alarm when this distance exceeds a predetermined threshold.

Some known anti-theft devices are also configured to allow geolocation of the stolen item.

Examples of these prior art anti-theft devices are described in U.S. Pat. No. 10,643,441B1, CN112566031A, US20210256169A1 and CN104809839B.

However, such devices are incompatible for use as anti-theft device for luxury watches for different reasons.

In fact, to control the distance between the item to be protected and a reference device, some of them use radio signals exchanged between said reference device and a communications module integrated in the item to be protected.

As is known, as almost all luxury watches are of analogue type, more precisely of mechanical type, i.e., without any electronic components, it is evident that anti-theft devices of this type cannot be used.

Other known anti-theft devices instead comprise a part to be attached or fixed to, or integrated in, the item to be protected, said part comprising electronic components (communications modules, accelerometers, GPS, etc.) which allow the movements of item, the distance from a reference device and/or its position to be detected.

Comprehensibly, these prior art devices, where attached externally to the wristwatch, even if they are removable, would have a decidedly negative impact on the appearance of this type of item.

On the other hand, in view of the fact that the economic value of these items is greatly linked to their authenticity, it is inconceivable to consider irreversibly modifying the structure of the wristwatch to be able to integrate the aforesaid components of the anti-theft device.

### SUMMARY OF THE INVENTION

In this context, the object of the present invention is to propose an alarm and geolocation system for watches, in particular analogue watches, which overcomes the aforesaid limits of the prior art.

In particular, the object of the present invention is to produce an alarm and geolocation system for analogue watches, which does not require any aesthetic or functional modification of the watch, thereby preserving its authenticity.

More in detail, the object of the present invention is to produce a system capable of detecting the potential theft of the wristwatch from the person wearing it and of generating an alarm that can be notified to various interested parties.

The object of the present invention is also to provide a system comprising an alarm device, to be fixed permanently to the wristwatch, capable both of detecting the relative position with respect to a reference device, and of tracking its global geographical position.

A further object of the present invention is to provide a system comprising an alarm device which is completely hidden from view, or integrated, or which cannot be detected and fraudulently removed.

These and other objects are achieved by an alarm and geolocation system for watches, in particular for analogue watches, in conformity with claim 1.

The objects of the present invention are also achieved by an alarm device attachable to wristwatches, in particular to analogue wristwatches, in conformity with claim 13.

More in detail, according to the present invention, the system comprises at least one alarm device attachable to a wristwatch and at least one reference device. According to some variants of the present invention, as will be illustrated in detail below, the system can further comprise a remote processing and storage unit and optionally one or more authorized electronic devices and one or more enabled portable electronic devices.

According to the invention, the alarm device comprises at least:
a) a short range communications module provided with antenna:
b) a processor connected to the short range communications module; and
c) an energy storage device:
d) at least one supporting and containing element.

The short range communications module, the processor, the energy storage device, and any other components of the alarm device provided for some variants, are housed in said at least one supporting and containing element.

According to the invention, the supporting and containing element is equipped with connection means that allow it to be permanently fixed to the watch.

Advantageously, according to the invention, said supporting and containing element is structured in such a way that it can be attached in place of a crown, a clasp, a link of the bracelet or, according to a preferred variant, a fixing pin of the bracelet of the wristwatch.

In the last case, i.e., with the supporting and containing element in the form of a pin, besides being quick and easy to remove and reassemble, without the risk of damaging the wristwatch, it is a component completely hidden from view.

Therefore, with this configuration, it is possible to integrate the alarm device as described above in the wristwatch, even of analogue/mechanical type, without any relevant modifications and retaining its authenticity.

Moreover, this operation is completely reversible, as the supporting and containing element can be removed at any time and replaced with the original pin of the wristwatch.

According to other embodiments, the supporting and containing element can be attached or, more typically, can replace the respective parts (crown, link or clasp). In these cases, as these components are visible, it is sufficient to use a replacement element with a form corresponding in shape and size to those of the part of the wristwatch, and made with identical or equivalent materials.

Also in these cases, the parts can be removed and replaced easily and in a completely reversible manner, so as to safeguard the full value of the wristwatch.

According to the invention, the alarm device can comprise even more than one containing element, where each of these elements carries specific components of the device, as will be better illustrated below.

According to the invention, the reference device comprises a short range communications module configured to exchange signals and/or data with the short range communications module of the alarm device.

Said reference device is typically of wearable or portable type. Typically, the reference device is carried by the person wearing the wristwatch and, more in general (as will be better explained hereunder) must be maintained at a certain distance from the wristwatch.

According to some variants of the invention, the device is in the form of a “tag”, i.e., it comprises an outer casing of small size (with a maximum length/width/height ranging from a few millimetres to 3-4 cm), which can be kept in a pocket or fixed to keys, belts, bags or any other item usually carried by the person.

According to other variants of the invention, said reference device can be included or integrated in a portable electronic device such as a smartphone, a tablet, a smartwatch or, more generally, a device comprising at least one short range communications module (for example Bluetooth or the like).

More in detail, according to the invention, the short range communications module of the reference device is configured to send a control signal containing at least a unique identifier of the alarm device. Said signal is typically sent in broadcast mode.

The short range communications module of the alarm device is in turn configured to receive, continuously or at predetermined intervals of time, said control signal.

As will be better explained hereunder, said control signal is used to calculate the distance between the alarm device, and hence the wristwatch to which it is attached, and the reference device, i.e., for example, the person wearing the wristwatch.

The unique identifier contained in the control signal sent by the reference device instead allows the alarm device to identify said control signal with respect to any other signals emitted by other devices in the vicinity.

According to a preferred variant, the short range communications module of the reference device and the short range communications module of the alarm device are configured to exchange respective signals in beacon frame mode, i.e., comprising beacon frames.

According to another aspect of the invention, the short range communications module of the alarm device can comprise a BLE (Bluetooth Low Energy) module. This configuration allows energy consumption to be minimized, making it possible to use an energy storage device of very small size, compatible with the sizes of the aforesaid supporting and containing elements.

To further reduce energy consumption, the short range communications module of the alarm device can be controlled by the processor so as to operate with on/off mode, i.e., placing the module in a deactivated state (“sleep mode”) for a period T1_{off} and in a short activated state for a period T1ₒₙ with T1_{off}>>T1ₒₙ.

In the activated period T1ₒₙ the processor analyses the data packets received in broadcast mode and verifies the presence of at least one packet with the expected unique identifier.

After identifying the signal coming from the reference device, the processor is programmed to calculate, on the basis of at least one physical parameter of said signal, the distance between the alarm device and the reference device. According to a typical embodiment, said parameter is the RSSI (Received Signal Strength Indicator) of the signal.

As a function of this parameter, the processor is further programmed to define the state of the alarm device between a quiet state, when the distance calculated between said alarm device and the reference device is below a predetermined threshold, and an alarm or pre-alarm state, when said distance is above the predetermined threshold.

This limit distance is generally below the typical range of the signal of short range communications modules. In this way, the absence of a signal containing the unique identifier is also interpreted as a distance above the threshold distance. Therefore, when the wristwatch with the alarm device is moved too far away from the reference device, for example if the wristwatch is removed or snatched from the person wearing it, the processor of the alarm device, no longer receiving the control signal containing the unique identifier, detects this event and generates an alarm or pre-alarm state.

As a function of the configuration of the different variants of the system and of the alarm device, which will be described below, this alarm or pre-alarm state detected allows interested and authorized parties to be informed of this event.

Said authorized parties can, for example, include the person wearing the wristwatch, the owner (who may not be the person wearing it), an insurance company, etc.

Moreover, as will be explained below, the system of the present invention allows said authorized parties to receive information relating to the geolocation of the alarm device, hence of the wristwatch.

According to an aspect of the invention, as mentioned above, the system further comprises a remote processing and storage unit (hereinafter, for simplicity, “remote unit”) connected to the Internet. Said remote unit is typically a cloud platform or, more in general, a distributed processing environment that allows users to access and use information resources, such as processing capacity, storage space and networks, via the Internet.

According to the invention, said remote unit is configured to receive from the alarm device or, as will be explained below, from another enabled device, information relating to the alarm, or pre-alarm, state of a specific alarm device (identified through the control signal containing the unique identifier) and, preferably, information relating to the geolocation of this alarm device.

The remote unit is further configured to send said information relating to the state of the device and to its geolocation to one or more authorized electronic devices.

According to a first preferred embodiment of the invention, the alarm device further comprises a long range communications module and a GPS module, also housed in the supporting and containing element (or in the supporting and containing elements if these are more than one).

The long range communications module is connected to the processor and is configured to access geographical networks (WAN) and hence to connect to the Internet to exchange data with the remote unit.

Said long range communications module is preferably of low energy consumption type such as LoraWan, SIGFOX, NB-IOT or equivalent.

Again in order to reduce energy consumption, the system is preferably configured to maintain said long range communications module normally deactivated in the quiet state of the alarm device and to activate said long range module only in the pre-alarm or alarm state.

Therefore, according to this variant, when the processor, through analysis of the control signal or in the absence of this control signal, detects a distance from the reference device above the threshold distance, it can take the device to a pre-alarm state in which it activates the long range communications module.

Via the long range communications module, the alarm device sends the remote unit a signal containing at least the unique identifier of the alarm device and at least information relating to the change of state from quiet to pre-alarm.

The remote unit is in turn configured to send a request for confirmation of alarm state or for cancellation of the pre-alarm state to at least one authorized electronic device.

The authorized electronic device is typically connected to the Internet to communicate with the remote unit. Said authorized electronic device can comprise, for example, a smartphone, a tablet, a computer, etc.

Typically, these authorized devices are equipped with a program or with an application that allows the exchange of information with the remote unit. However, information can be sent from the remote unit to the authorized device also via e-mail, SMS or the like.

Upon receiving the request, an authorized party can cancel the pre-alarm state, for example when the person wearing or in possession of the wristwatch, either intentionally or unintentionally, moved farther away, or can confirm the alarm state, for example in the case of theft (snatching, robbery, etc.) or loss of the watch.

The signal containing the information of the response (cancellation or confirmation) of the authorized subject, is sent from the authorized device to the remote unit and is forwarded by the latter to the alarm device, again via the Internet.

If the authorized party cancels the pre-alarm state, the processor switches the state of the alarm device from alarm to quiet.

According to an embodiment, after cancellation of a pre-alarm state, the processor can be configured to inhibit or suspend analysis of the control signal for a predetermined time (for example 30 seconds, 1 minute, etc.) or to delay further switching into pre-alarm state for a predetermined time (for example 30 seconds, 1 minute, etc.), also in the case in which the distance calculated between the alarm device and the reference device is still above the predetermined threshold.

In this way, the person wearing, or in possession of, the wristwatch can move the reference device closer to the wristwatch, or vice versa.

Instead, if the authorized party confirmed the pre-alarm state, the processor switches the state of the alarm device from pre-alarm to alarm.

In this state the processor also activates the GPS module and, via the long range communications module, sends the remote unit a signal containing at least information relating to the geolocation (geographical coordinates) of the alarm device and at least information relating to the unique identifier of the alarm system.

This information is forwarded by the remote unit to the authorized devices.

Again to limit energy consumption, the time for which the GPS module is switched on and for sending data to the remote unit can be defined at regular intervals. These intervals are established based on the type of supporting and containing element, i.e., based on the capacity of the storage device housed in the element.

According to a variant of the invention, the alarm device can however have only two states—quiet and alarm.

In this variant, when the processor, through analysis of the control signal, detects a distance from the reference device above the threshold distance, it places the device directly in alarm state activating both the long range module and the GPS module.

In this case, the signal sent to the remote unit contains at least the unique identifier of the alarm device and at least the information relating to the change of state from quiet to alarm and to the geolocation of the alarm device.

The information is then sent from the remote unit to the authorized devices as described above.

Due to the system according to the present invention it is thus possible to detect, practically in real time, an event of loss or possible theft of the wristwatch from the person wearing it, notify said event to one or more authorized parties and send them information on the geographical position of the wristwatch, so as to facilitate its potential recovery.

It is specified that the system of the present invention can also be used effectively as anti-theft device when the watch is not being worn by a person but is instead kept in a specific position, for example when it is kept in the home or stored in a safe place.

In this case, it is sufficient to place the reference device in the vicinity of the watch, below the threshold distance, preferably in a place where it is not visible.

Any movement of the watch with respect to the reference device would in fact cause the same process of verification of the distance and generation of the alarm described above.

According to an aspect of the invention, which can be applied to all the variants described, the reference device can be configured to send control signals to the alarm device, for example activation/deactivation signals.

In the case in which the reference device is a Bluetooth beacon, it can be equipped with at least one button which when pressed causes said control signal to be sent.

For example, in the case of sending a deactivation signal, the processor of the alarm device can be configured to maintain the device in quiet state regardless of the distance detected by the reference device. More in particular, according to a preferred variant, the processor can interrupt parsing of external signals to reduce energy consumption.

Sending of an activation signal instead returns the device to the operating conditions described above.

Said activation/deactivation control signal can also be sent from a smartphone, from a smartwatch or from a tablet, when used as reference devices.

According to another variant of the invention, the alarm device is produced in a more simplified form and is not provided with the GPS module.

According to this variant, operation is identical to that of the preceding version, except for the method of detecting the geographical position of the alarm device, i.e., the watch.

More in detail, the processor can be programmed to calculate the geographical position of the alarm device as a function of parameters of signals exchanged between the long range communications module of the alarm device and the base or gateway radio stations at its radio range.

This calculation, just as in the previous version, is carried out after the alarm device has received confirmation of the alarm (sent by one of the authorized devices) from the remote unit or, where no pre-alarm state is provided for, directly after detecting that the distance is above the threshold distance.

Geolocation can take place through the implementation of calculation methods known in the telecommunications field, such as Cell ID based, Signal strength based, Angle Of Arrival (AOA), Direction Of Arrival (DOA), Direction Finding (DF), Time Of Arrival (TOA), Time Difference Of Arrival (TDOA), Multipath analysis.

According to another even more simplified variant of the invention, the alarm device is not provided with the GPS module or the long range communications module.

According to this variant, the system also uses one or more third party portable electronic devices, identified here as enabled portable devices, to transmit signals to the remote unit containing the unique identifier of the alarm device and information relating to its state and its geographical position.

Said enabled portable devices comprise at least:
a short range communications module enabled to exchange signals and/or data with the short range module of the alarm device:
a long range communications module configured to communicate with base radio stations to connect to the Internet; and
a GPS module.

The enabled portable devices are in general smartphones or smartwatches.

According to this variant, the alarm device, in alarm state, is configured to send in broadcast mode, through the short range module, a signal containing at least the unique identifier and information relating to the alarm state.

The signal can optionally comprise other data such as the date and time of switching of the alarm state, etc.

Said third party enabled devices, due to native configurations, i.e., implemented in the operating system, or added through the installation of a software application (APP), are able to receive and analyse the signal produced and sent in broadcast mode by the alarm device.

More precisely, these enabled devices are able to understand whether a signal received was sent by a specific alarm device (installed on a wristwatch) placed in alarm state.

In this case, the enabled device can send the remote unit a signal containing at least information relating to the encounter with this alarm device (i.e., a condition of vicinity within the range of the signals of the short range modules), to the geographical position (obtained due to the GPS module integrated in said enabled device) and to an approximate distance from the GPS position indicated.

This approximate distance is preferably calculated again via the RSSI of the signal emitted by the short range module of the alarm device (in this case calculated by the enabled device) or physical quantities linked thereto.

The procedure of sharing the information from the remote unit with the authorized parties is instead identical to the one described for the other versions.

With this last variant described, especially in the case of a native application in the operating system of the enabled portable device (smartphone or smartwatch), there is a very high probability that, within a limited time span, the alarm device (hence the watch) will be close (i.e. within the radio range of short range modules) to one or more enabled devices which can share its alarm state and geolocation.

### BRIEF DESCRIPTION OF THE DRAWINGS

Further features and advantages of the present invention will be more apparent from the description of an example of embodiment, as illustrated in the accompanying figures, wherein:

FIG. 1 is a representation of a perspective view of a watch equipped with the alarm device according to the present invention;

FIG. 2 is a schematic representation of a perspective view of the alarm device according to a variant of the present invention:

FIG. 3 is a schematic representation of a perspective view of the alarm device of FIG. 2, partially disassembled:

FIG. 4 is a schematic representation of the alarm and geolocation system, according to a variant of the present invention:

FIG. 5 is a schematic representation of the operating steps of the alarm system of FIG. 4;

FIGS. 6a and 6b are schematic representations of two conditions of use of the alarm device of the system according to the present invention:

FIGS. 7 and 8 are schematic representations of the alarm and geolocation system, according to some variants of the present invention:

FIG. 9 is a representation of a perspective view of a watch equipped with the alarm device according to another variant of the present invention.

### DETAILED DESCRIPTION

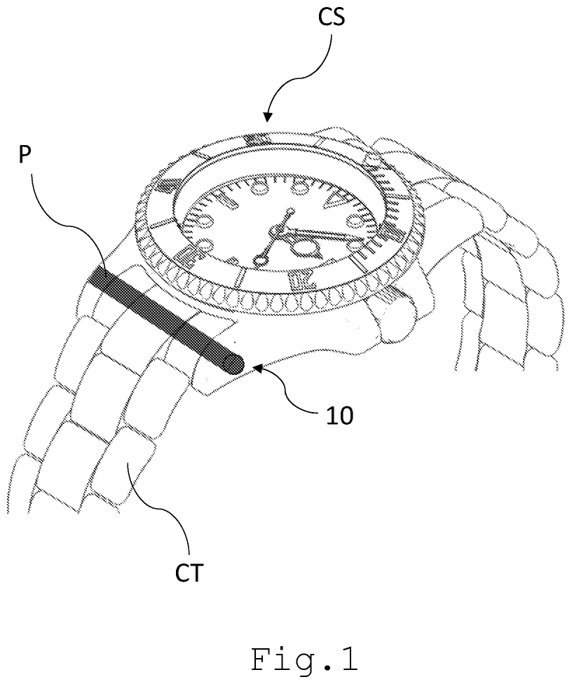

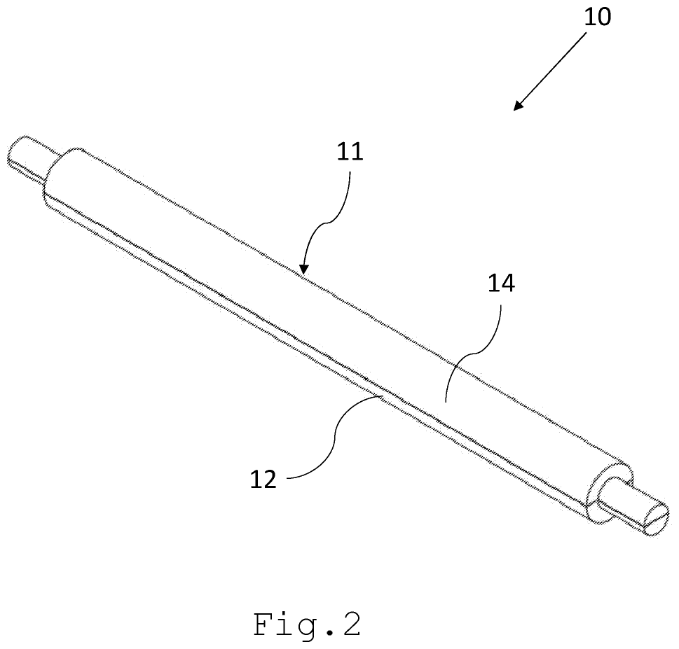

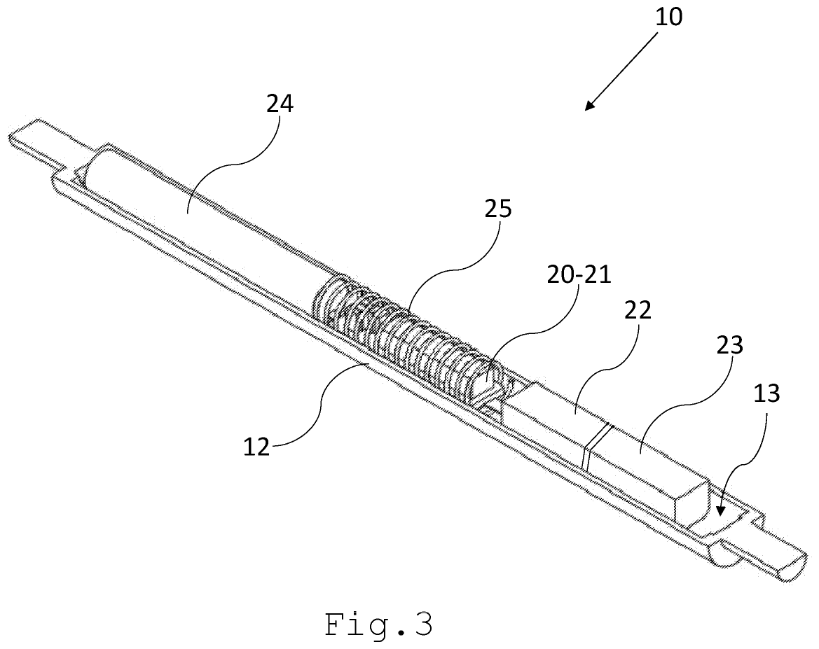

With reference to the accompanying FIG. 1, this depicts an analogue watch of mechanical type on which an alarm device 10 is fitted in place of the pin P that connects the first link of the bracelet CT to the case CS.

The alarm device 10 comprises a supporting and containing element 11 in the shape of a pin, i.e., comprising a thin and elongated cylindrical body.

The supporting and containing element 11 comprises a first structural portion 12 and a cover 14. Said structural portion 12 is typically made of metal, such as steel or titanium, and is suitable to ensure the mechanical strength of the connection between the bracelet CT and the case CS.

Said structural portion 12 has a hollow semi-cylindrical profile, for a part or for the whole of its length, in the cavity 13 of which the components of the alarm device 10 are housed.

Said cavity 13 is closed by the cover 14, also with a semi-cylindrical profile. The cover 14 is typically made of a polymeric material, such as polycarbonate, transparent to electromagnetic waves, i.e., which allows electromagnetic waves to pass through its thickness without being attenuated or absorbed to any great extent, hence without being subject to loss of energy.

The components installed in the supporting and containing element 11, more precisely in the cavity 13 of the structural portion 12, are a processor 20 which integrates a BLE (Bluetooth Low Energy) module 21, a low energy consumption long range wireless communications module 22, such as LoraWan, SIGFOX, NB-IoT or equivalent, a GPS module 23 and an energy storage device 24.

According to a preferred variant, the alarm device can further comprise an induction charging module provided with a receiver coil 25, to charge the energy storage device 24.

The cover 14 has the function of protecting the aforesaid components both from a mechanical viewpoint and from dust or water.

As mentioned above, the supporting and containing element 11 has the same size as the original pin of the wristwatch so as to be installed rapidly, without difficulty and in a completely reversible manner.

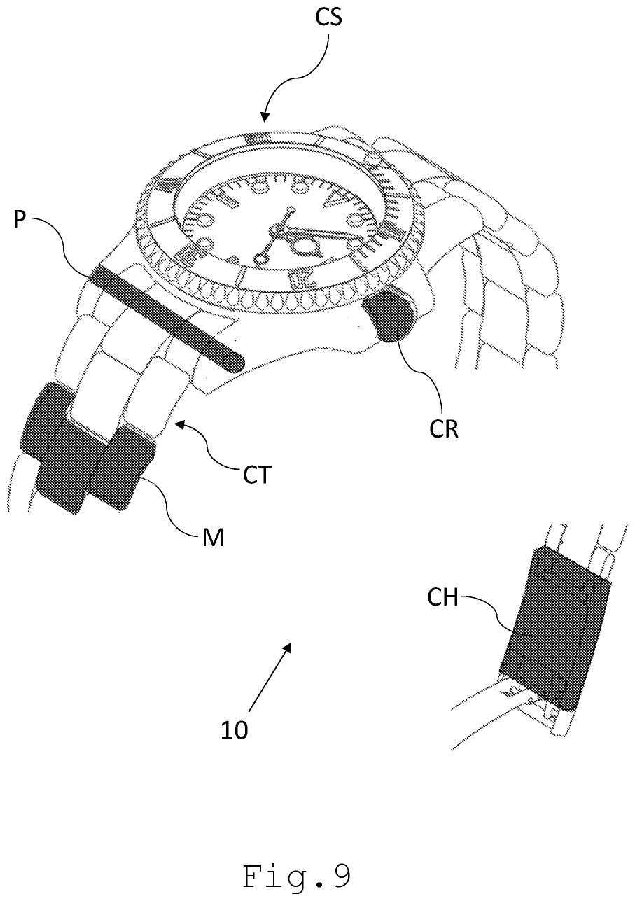

According to the present invention, the alarm device 10 can comprise two or more containing elements 11, for example structured to replace other parts of the wristwatch, such as a link M, a crown CR or a clasp CH, as shown in the example of FIG. 9.

In this variant of the alarm device, the various components can be distributed in more than one supporting and containing element 11 to overcome problems of housing space. In this variant, each supporting and containing element is typically equipped with a energy storage device to supply the respective components installed thereon.

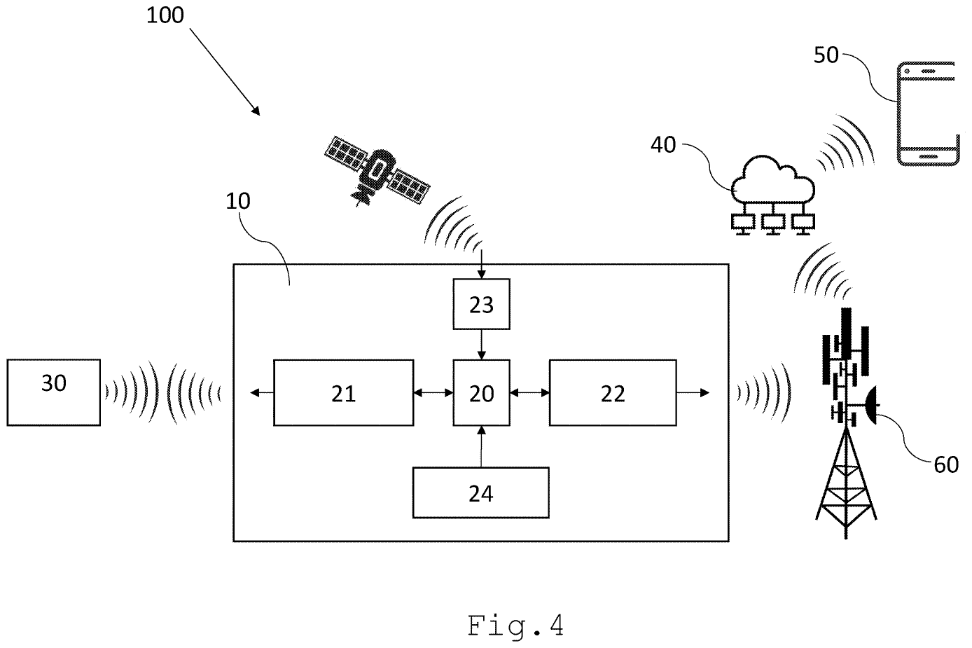

FIG. 4 schematically illustrates the alarm and geolocation system according to the present invention, indicated as a whole with the number 100.

The system 100 comprises the alarm device 10 described above, a beacon 30, equipped with a BLE (Bluetooth Low Energy) module, and a cloud platform 40, which acts as remote processing and storage unit.

The beacon 30 is typically a device of small size, hence portable, such as a keyring, a tag or the like.

According to another variant of the invention, the beacon 30 can be replaced by a smartphone equipped with a Bluetooth module. Also in this case, the smartphone must preferably be carried by the person wearing the watch.

The Bluetooth beacon is associated uniquely with the alarm device 10 by means of sharing a unique identifier.

According to the invention, the beacon 30 is configured to send a signal in broadcast mode, where said signal comprises a beacon frame containing a unique identifier of the alarm device.

An example of beacon frame, here named BEACON_PAYLOAD, sent in broadcast mode by the BLE module of the beacon 30, is the following:

DIGIT_KEY

where DIGIT_KEY is an integer from 0 to 999.999.999 and represents a unique identifier code of the alarm device, for example DG000000154. The beacon 30 of the person wearing the wristwatch can thus send the DIGIT_KEY 000000154 in broadcast mode to allow the alarm device 10 installed on the wristwatch to receive the signal.

The module BLE 21 of the alarm device is configured to receive and analyse said signal recognizing the unique identifier.

According to a variant of the invention, also the BLE module of the alarm device 10 is configured to send in broadcast mode, preferably at predetermined intervals, a signal comprising a Beacon frame.

An example of beacon frame, here named WATCH_PAYLOAD, sent in broadcast mode by the BLE module 21, is the following:

| | | |
|---|---|---|
| X | DIGIT_KEY | BATTERY_LEVEL |

where:
X: is an integer with two possible values: 1=Quiet state, 0=Alarm state:
DIGIT_KEY: is an integer from 0 to 999.999.999 and represents the unique identifier of the alarm device 10;
BATTERY_LEVEL: is an integer from 0 to 99 and indicates the % of charge of the energy storage device 24.

In the example of a WATCH_PAYLOAD corresponding to X1DG000000154BL55, the alarm device with DIGIT_KEY 000000154 is in quiet state and has a battery charge level of 55%.

The signals sent by the beacon 30 and/or by the BLE module 21 can be encrypted with protocols of various type, for example with symmetric key or asymmetric key.

The beacon 30 must be kept in the vicinity of the alarm device, i.e., of the wristwatch, for example at less than 10 metres, preferably at less than 5 metres, therefrom. When the watch is being worn, also the beacon 30 must be carried by the person.

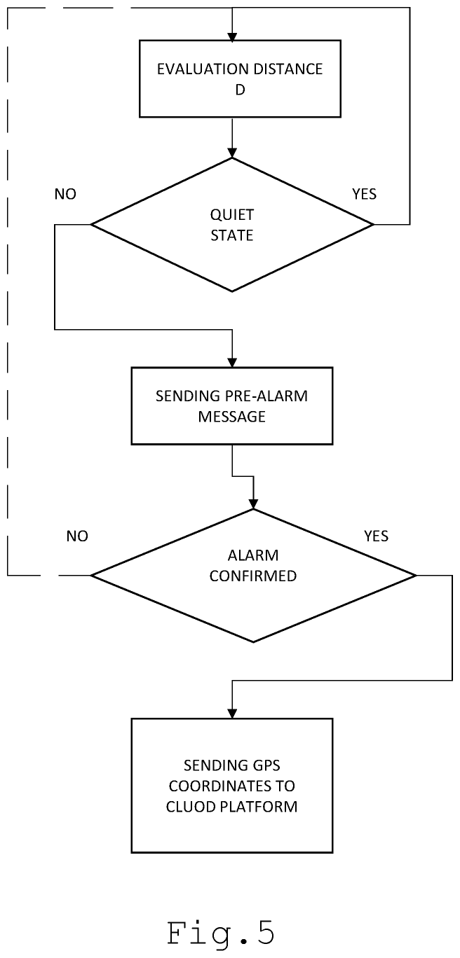

The flow diagram of operation of the alarm and geolocation system 100 is illustrated in FIG. 5.

The system 100 is based on the continuous verification of the distance D between the beacon 30 and the wristwatch, thanks to the alarm device 10 attached thereto.

As described in the previous paragraphs, the evaluation of said distance D is based on evaluation of the RSSI of the signal sent by the beacon 30 in broadcast mode. Verification of the unique identifier of the signal and calculation of the distance D is entrusted to the processor 20.

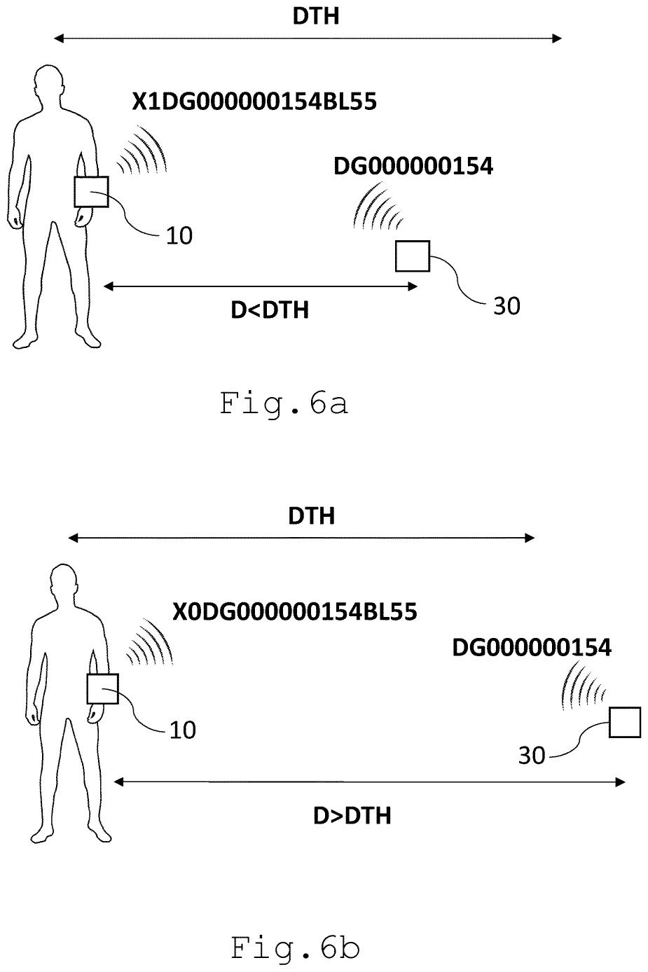

When the processor 20 calculates a distance D below a preset threshold distance DTH (FIG. 6a), it takes or maintains the alarm device 10 to/in quiet state.

Said calculation of the distance D is in general reiterated at regular intervals of time in the corresponding periods of activation of the modulo BLE 21.

If the distance D calculated by the processor 20 is above the threshold distance DTH, or if the BLE module 21 does not detect any signal with the correct unique identifier, the processor 20 takes the alarm device 10 from quiet state to pre-alarm state.

Simultaneously, the processor 20 activates the long range communications module 22 and sends the cloud platform 40 a signal containing the unique identifier of the alarm device 10 and information relating to the pre-alarm state.

The cloud platform 40 in turn sends, via the Internet, notification to at least one authorized device 50, for example a smartphone or a smartwatch equipped with an APP configured to exchange data with the cloud platform 40.

The authorized device 50 is in general carried by the person wearing the wristwatch, but can also be in the possession of the owner of the wristwatch, if this is not the person wearing it, or optionally of other parties entrusted to look after the watch. The authorized device 50 can also be a computer or another device, not necessarily portable.

Through the authorized device 50, an authorized subject can cancel or confirm the pre-alarm state.

In case of cancellation, the cloud platform 40, which receives the reply from the authorized subject, sends a corresponding signal to the alarm device 10 the processor 20 of which switches the alarm back into quiet state.

Instead, in case of confirmation of the pre-alarm state, the processor 20 switches the state of the device from pre-alarm to alarm and activates the GPS module 23. The long range module 22, then sends the cloud platform 40 a signal containing the unique identifier and information relating to the alarm state 10 of the device and to its geographical position, detected by the GPS module 23.

The cloud platform 40 in turn sends, via the Internet, the authorized device 50 a signal containing said unique identifier and said information relating to the alarm state 10 of the device and to its geographical position.

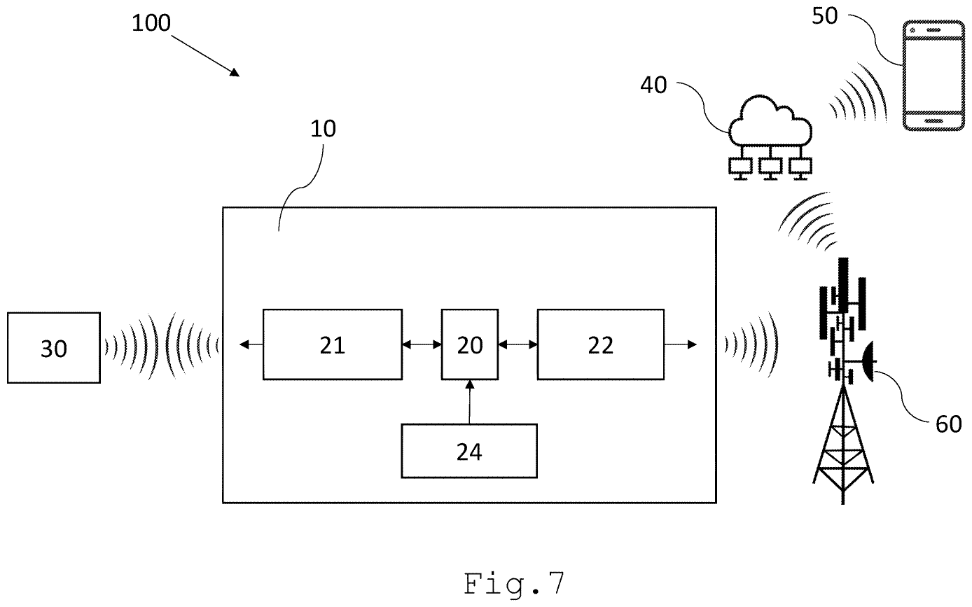

FIG. 7 is a schematic representation of the system 100 wherein the alarm device 10, with respect to the previous variant, is not provided with GPS module. This variant, besides being more compact due to the absence of the GPS module, has a lower energy consumption, and can thus operate with an energy storage device 24 of smaller capacity and size.

According to this variant, the geographical position when the alarm device 10 is in alarm state, is calculated through some known algorithms exploiting signals exchanged by the long range module 22 and the base radio stations 60.

The remaining operating steps of the system 100 are substantially identical to those described previously.

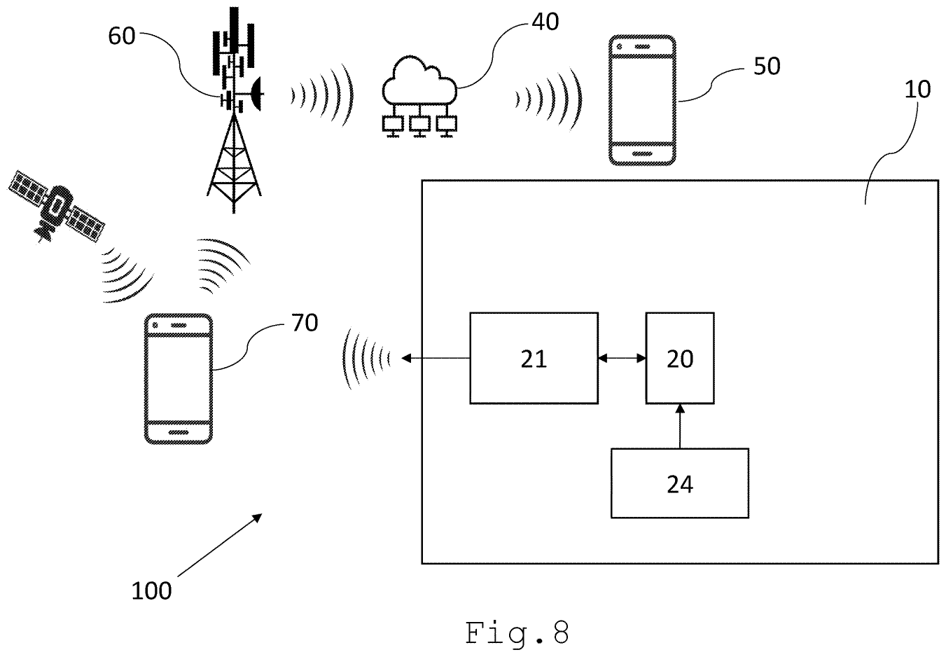

FIG. 8 is a schematic representation of the system 100 wherein the alarm device 10, with respect to the variant of FIG. 7, is also without the long range communication module 22. This variant is even more compact and consumes even less energy than the previous one.

Calculation of the distance D is the same as described for the other variants. However, with this variant, when the processor 20 detects a distance D above the threshold DTH, it switches the device directly into alarm state and controls the BLE communications module 21 to send a signal in broadcast mode with a beacon frame containing the unique identifier and the alarm state, for example like the WATCH_PAYLOAD described above.

With this variant of the system 100, enabled devices 70 of third parties, typically smartphones or smartwatches, can be enabled to receive said signal sent by the BLE module 21 and to process it.

To do so, said enabled devices are equipped with an application specifically configured or, preferably, with a native function integrated in the operating system.

When one of said enabled devices 70 is within the radio range of the BLE module 21, the Bluetooth module of said enabled device receives the signal containing the beacon frame which can be recognized and processed through the application installed.

More precisely, the authorized device 70 is configured to send the cloud platform 40, via a long range communications module with which it is equipped, a signal containing the unique identifier and information relating to the alarm state of the alarm device and to its approximate geographical position. Said approximate geographical position can correspond to the position detected by the GPS integrated in said enabled device 70, or can be recalculated as a function of the RSSI of the signal sent by the BLE module 21.

The information is then sent by the cloud platform 40 to the authorized device 50 with the same methods described previously.

The invention has been described purely for illustrative and non-limiting purposes, according to some preferred embodiments. The person skilled in the art may find numerous other embodiments and variants, all falling within the scope of protection of the appended claims.

1.-15. (canceled)

16. An alarm and geolocation system for watches, in particular for analogue watches, comprising:
an alarm device attachable to a wristwatch, said alarm device comprising at least:
a) a short range communications module provided with antenna;
b) a processor connected to the short range communications module;
c) an energy storage device;
d) at least one supporting and containing element configured to be fixed permanently to the wristwatch, said supporting and containing element being chosen from at least a crown (CR) or a pin (P), clasp (CH) or link (M) of a bracelet;
wherein said short range communications module, said processor and said energy storage device are housed in said at least one supporting and containing element; and
a reference device comprising a short range communications module configured to exchange signals and/or data with the short range communications module of the alarm device, said reference device being of wearable and/or portable type;
wherein the short range communications module of the reference device is configured to send a control signal containing at least a unique identifier of the alarm device, wherein the short range communications module of the alarm device is configured to receive, continuously or at predetermined intervals of time, said control signal and wherein the processor is programmed to analyse said signal and to calculate, based on at least one parameter of said signal, the distance (D) between the alarm device, hence the wristwatch to which it is attached, and the reference device, the processor being further programmed to switch the state of the alarm device from a quiet state, maintained when the distance (D) calculated between said alarm device and the reference device is below a predetermined threshold (DTH), to an alarm or pre-alarm state, when said distance (D) is above the predetermined threshold (DTH).

17. The system according to claim 16, further comprising a remote processing and storage unit connected to the Internet, the alarm device being configured to exchange data, directly or indirectly, with said remote processing and storage unit.

18. The system according to claim 17, wherein the alarm device further comprises a long range communications module, also housed in the supporting and containing element, said long range communications module being connected to the processor being configured to connect to geographical networks to connect to the Internet, to exchange data with the remote processing and storage unit.

19. The system according to claim 18, wherein when the processor establishes a change of state of the alarm device from quiet to pre-alarm or alarm, the long range communications module is configured to send the remote processing and storage unit a signal containing at least the unique identifier of the alarm device and information relating to the change of state.

20. The system according to claim 19, wherein, when the processor establishes a change of state of the alarm device from quiet to alarm, said processor is further programmed to calculate the geographical position of the alarm device according to parameters of signals exchanged between the long range communications module and the base radio stations or gateways within radio range, and wherein said signal sent to the remote processing and storage unit further contains information relating to said geographical position of the alarm device.

21. The system according to claim 19, wherein the remote processing and storage unit is configured to receive said signal containing at least the unique identifier and information relating to the change of state of the alarm device, and to its geographical position, and to send, via the Internet, a corresponding signal to at least one authorized electronic device connected to the Internet.

22. The system according to claim 21, wherein, when the distance (D) calculated between the alarm device and the reference device is above the predetermined threshold (DTH), the processor is programmed to switch the state of the alarm device to a pre-alarm state and to send the remote processing and storage unit, via the long range communications module, a signal containing the unique identifier and at least information relating to the change of state of the alarm device, and wherein said remote processing and storage unit is configured to send the at least one authorized electronic device a request for confirmation of alarm state or of cancellation of the pre-alarm state.

23. The system according to claim 19, wherein the alarm device further comprises a GPS module connected to the processor, and also housed in the supporting and containing element, and wherein, when the processor establishes a change of state of the alarm device from quiet to alarm, said processor is programmed to detect the geographical position of the alarm device and to send the remote processing and storage unit a signal also containing information relating to said geographical position of the alarm device.

24. The system according to claim 21, wherein the remote processing and storage unit is configured to send said at least one authorized electronic device a corresponding signal containing information relating to the geographical position of the alarm device.

25. The system according to claim 17, further comprising one or more enabled electronic devices comprising at least:
a short range communications module enabled to exchange signals and/or
data with the short range module of the alarm device;
a long range communications module configured to communicate with base radio stations to connect to the Internet;
a GPS module;
wherein said enabled electronic device is configured to receive from the short range module of the alarm device a signal containing at least the unique identifier of the alarm device and information relating to the alarm state, and to send the remote processing and storage unit a corresponding signal further containing the geographical position of said alarm device, in an interval of time in which the short range communications module of the enabled electronic device received the signal from the short range communications module of the alarm device.

26. The system according to claim 19, wherein the reference device is a BLE (Bluetooth Low Energy) beacon or is a portable electronic device equipped with a Bluetooth module configured to exchange signals and/or data in Bluetooth Low Energy mode.

27. The system according to claim 19, wherein the short range communications module of the alarm device and the short range communications module of the reference device are configured to send and/or receive signals in beacon frame mode.

28. An alarm device attachable to a wristwatch, in particular to an analogue wristwatch, said alarm device comprising at least:
a) a short range communications module provided with antenna;
b) a processor connected to the short range communications module;
c) an energy storage device;
d) at least one supporting and containing element configured to be permanently fixed to the wristwatch,
where the supporting and containing element is chosen from at least a crown (CR) or a pin (P), clasp (CH) or link (M) of a bracelet.

29. The alarm device according to claim 28, comprising a long range communications module housed in the supporting and containing element.

30. The alarm device according to claim 28, comprising a GPS module housed in the supporting and containing element.
